(19) United States
(12) Patent Application Publication
(10) Pub. No.: US 2006/0177077 A1
(43) Pub. Date: Aug. 10, 2006

(54) High frequency mixer circuit

(75) Inventors: Yasuyuki Okada, Ashikaga-shi (JP); Akihito Nagamatsu, Ora-gun (JP); Katsuaki Onoda, Hanyu-shi (JP); Shigehiro Nakamura, Ora-gun (JP); Mikito Sakakibara, Kumagaya-shi (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Moriguchi-shi (JP)

(21) Appl. No.: 11/350,442

(22) Filed: Feb. 9, 2006

(30) Foreign Application Priority Data
Feb. 10, 2005 (JP) 2005-034394

(51) Int. Cl. H04B 1/00

(52) U.S. Cl. 381/119

(57) ABSTRACT

A high frequency mixer circuit is used as a down converter in which an RF signal and an LO signal are mixed to generate an IF signal, or as an up converter in which an IF signal and an LO signal are mixed to generate an RF signal. The high frequency mixer circuit has a wiring layout wherein wiring lines for propagating LO signals intersect only one of the wiring lines for propagating RF signals or IF signals.

### CROSS-REFERENCE TO RELATED APPLICATION

The entire disclosure of Japanese Patent Application No. 2005-34394 including the specification, claims, drawings, and abstract is incorporated herein by reference.

### BACKGROUND OF THE INVENTION

1. Field of the Invention

The present invention relates to a high frequency mixer circuit in which isolation between signals is improved.

2. Description of the Related Art

In wireless communication, a frequency conversion circuit (high frequency mixer circuit) is commonly used to down-convert a received radio frequency signal (RF signal) to an intermediate frequency signal (IF signal) having a lower frequency, or to up-convert an IF signal to an RF signal having a higher frequency.

As an example of a high frequency mixer circuit, a quad ring circuit 100 as shown in FIG. 2 is known in the art. The quad ring circuit 100 has transistors Tr1 and Tr2, and transistors Tr3 and Tr4. Sources of the transistors Tr1 and Tr2 are directly connected to each other, and are connected to a first terminal T_{RF1} for RF signals. Sources of the transistors Tr3 and Tr4 are directly connected to each other, and are connected to a second terminal T_{RF2} for RF signals. Gates of the transistor Tr1 and the transistor Tr4 are connected to a first terminal T_{LO1} for local oscillation signals (LO signals). Gates of the transistor Tr2 and the transistor Tr3 are connected to a second terminal T_{LO2} for LO signals. Drains of the transistor Tr1 and the transistor Tr3 are connected to a first terminal T_{IF1} for IF signals. Drains of the transistor Tr2 and the transistor Tr4 are connected to a second terminal T_{IF2} for IF signals.

By inputting an RF signal having a frequency f_{RF} to a point between the first and second terminals T_{RF1} and T_{RF2} for RF signals, and inputting an LO signal having a frequency f_{LO} to a point between the first and second terminals T_{LO1} and T_{LO2} for LO signals, an IF signal obtainedby down conversion to a frequency (f_{RF}-f_{LO}) is output from a point between the first and second terminals T_{IF1,} and T_{IF2} for IF signals. Also, by inputting an IF signal having a frequency f_{IF} to a point between the first and second terminals T_{IF1} and T_{IF2} for IF signals, and inputting a local oscillation signal having a frequency f_{LO} to a point between the first and second terminals T_{LO1} and T_{LO2} for LO signals, an RF signal obtained by up conversion to a frequency (f_{IF}+f_{LO}) is output from a point between the first and second terminals T_{RF1} and T_{RF2} for RF signals.

FIG. 3 shows a circuit diagram of the quad ring circuit 100. Referring to Fig. 3, wiring used in a case where the transistor Tr1 is formed in an upper right region, the transistor Tr2 is formed in an upper left region, the transistor Tr3 is formed in a lower right region, and the transistor Tr4 is formed in a lower left region will be described below.

By introducing a dopant into a surface of a semiconductor substrate, source regions S and a drain region D (shown by broken lines in FIG. 3) are formed in each of the regions where the transistors Tr1 through Tr4 are to be formed. In each of the transistors Tr1 through Tr4, gate electrodes G are disposed in regions between the source regions S and the drain region D. The transistors Tr1 through Tr4 are each formed in this manner.

In the source regions, drain regions, and gate electrodes of the transistors Tr1 through Tr4, wiring is formed using a multi-layered metal wiring technique. Connection terminals are extended from the gate electrodes G of the transistor Tr1 in a direction toward the transistor Tr2, connection terminals are extended from the gate electrodes G of the transistor Tr4 in a direction toward the transistor Tr3, and a wiring line L1 is laid out from the respective connection terminals through between the transistors Tr2 and Tr4 to the first terminal T_{LO1} for LO signals that is located on the left side of the transistor Tr4. Connection terminals are extended from the gate electrodes G of the transistor Tr2 in a direction toward the transistor Tr1, connection terminals are extended from the gate electrodes G of the transistor Tr3 in a direction toward the transistor Tr4, and a wiring line L2 is laid out from the respective connection terminals through between the transistors Trl and Tr2 to the second terminal T_{LO2} for LO signals that is located on the left side of the transistor Tr2. The wiring lines L1 and L2 are formed in a multi-layered manner with an insulating layer interposed therebetween.

A wiring line L3 is extended from the source regions S of the transistor Tr1 in a direction away from the transistor Tr3, and is extended from the source regions S of the transistor Tr2 in a direction away from the transistor Tr4. The source regions S of the transistor Tr1 and the source regions S of the transistor Tr2 are electrically connected to each other, and the wiring line L3 is laid out from the respective source regions S to the first terminal T_{RF1} for RF signals that is located on the right side of the transistor Tr1. A wiring line L4 is extended from the source regions S of the transistor Tr3 in a direction away from the transistor Tr1, and is extended from the source regions S of the transistor Tr4 in a direction away from the transistor Tr2. The source regions S of the transistor Tr3 and the source regions S of the transistor Tr4 are electrically connected to each other, and the wiring line L4 is laidout from the respective source regions S to the second terminal T_{RF2} for RF signals that is located on the right side of the transistor Tr3. The wiring lines L3 and L4 are formed in a multi-layered manner on the wiring line L2 and a wiring line L5, respectively, with an insulating film interposed therebetween.

The wiring line L5 is extended from the drain region D of the transistor Tr1 in a direction away from the transistor Tr2, and is extended from the drain region D of the transistor Tr3 in a direction away from the transistor Tr4. The drain region D of the transistor Tr1 and the drain region D of the transistor Tr3 are electrically connected to each other, and the wiring line L5 is laid out from the respective drain regions D to the first terminal T_{IF1} for IF signals that is located below the transistor Tr3. A wiring line L6 is extended from the drain region D of the transistor Tr2 in a direction away from the transistor Trl, and is extended from the drain region D of the transistor Tr4 in a direction away from the transistor Tr3. The drain region D of the transistor Tr2 and the drain region D of the transistor Tr4 are electrically connected to each other, and the wiring line L6 is laid out from the respective drain regions D to the second terminal TIF2 for IF signals that is located below the transistor Tr4. The wiring lines L5 and L6 are formed in a multi-layered manner on the wiring lines L4 and L1, respectively, with an insulating film interposed therebetween.

However, the layout of the wiring lines L1 through L6 as shown in FIG. 3 includes a region “a” in which the wiring line L2 for LO signals and the wiring line L3 for RF signals overlap each other with an insulating film interposed therebetween, and a region “b” in which the wiring line L1 for LO signals and the wiring line L6 for IF signals overlap each other with an insulating film interposed therebetween. The conditions in the regions “a” and “b” are equivalent to the conditions in which a wiring line for RF signals or a wiring line for IF signals is connected to a wiring line for LO signals through a capacitor in a high frequency band.

With this being the situation, in the regions “a” and “b”, an LO signal having a high signal strength is mixed with an RF signal or an IF signal having a relatively low signal strength. Therefore, such high frequency mixer circuits have a problem in that the isolation between different signals is reduced.

### SUMMARY OF THE INVENTION

According to one aspect of the present invention, there is provided a high frequency mixer circuit intended for use as a down converter in which a radio frequency signal and a local oscillation signal are mixed to generate an intermediate frequency signal, or as an up converter in which an intermediate frequency signal and a local oscillation signal are mixed to generate a radio frequency signal, the high frequency mixer circuit having a wiring layout wherein first and second wiring lines for propagating local oscillation signals intersect only one of the wiring lines for propagating radio frequency signals or intermediate frequency signals.

### BRIEF DESCRIPTION OF THE DRAWINGS

A preferred embodiment of the present invention will be described in further detail based on the following drawings, wherein:

FIG. 1 shows an example of a wiring layout of a high frequency mixer circuit according to an embodiment of the present invention;

FIG. 2 shows a structure of a quad ring circuit; and

FIG. 3 shows a wiring layout of a related art quad ring circuit.

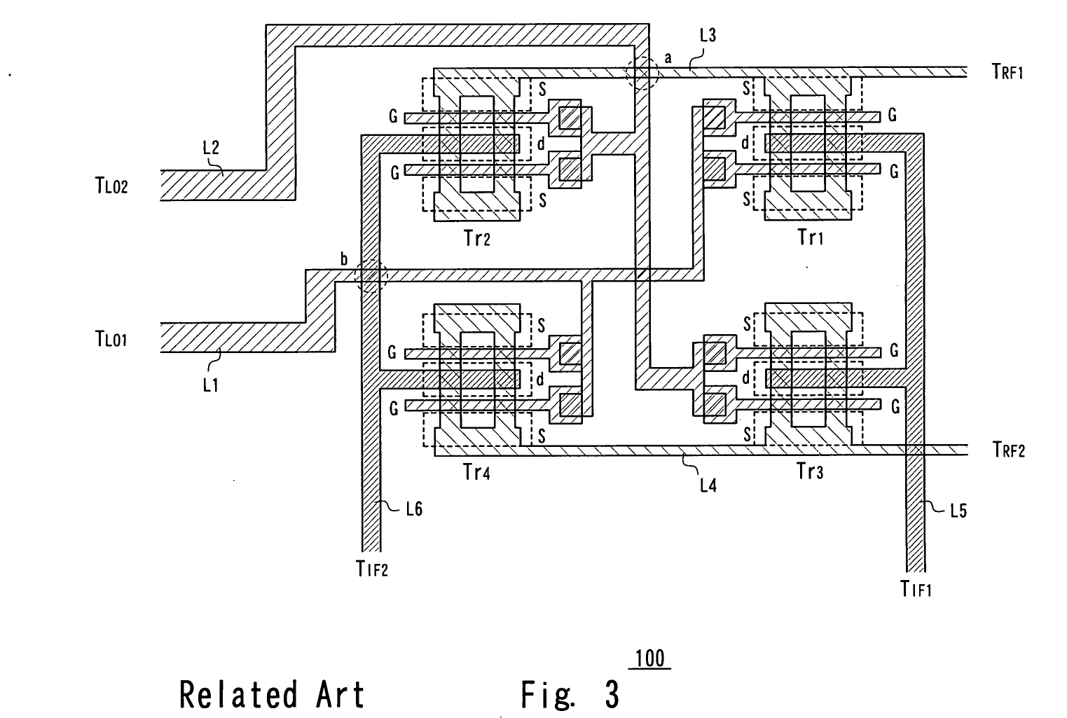

### DESCRIPTION OF PREFERRED EMBODIMENT

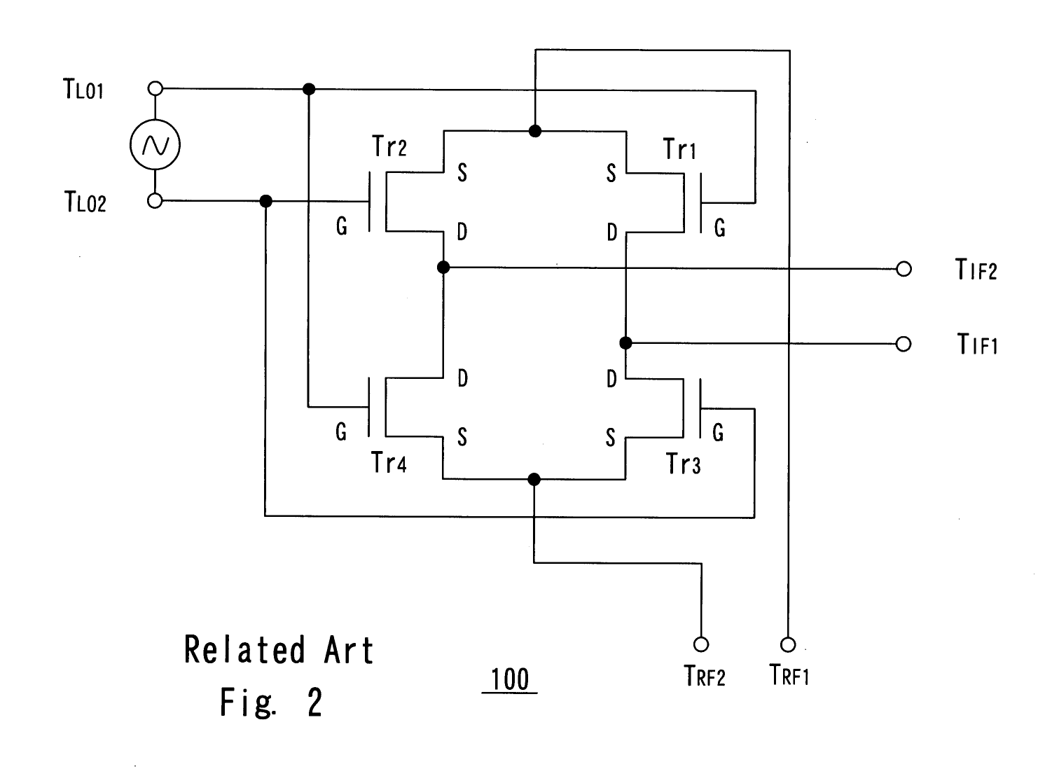

A high frequency mixer circuit according to an embodiment of the present invention is expressed as, for example, an equivalent circuit identical to the quad ring circuit 100 shown in FIG. 2. In other words, the present embodiment will be described taking as an example a case wherein the high frequency mixer circuit is a quad ring circuit having transistors Tr1 and Tr2, and transistors Tr3 and Tr4. However, the present invention is not limited to such an embodiment, and the technical idea of the present invention can also be applied to other types of structures of high frequency mixer circuits.

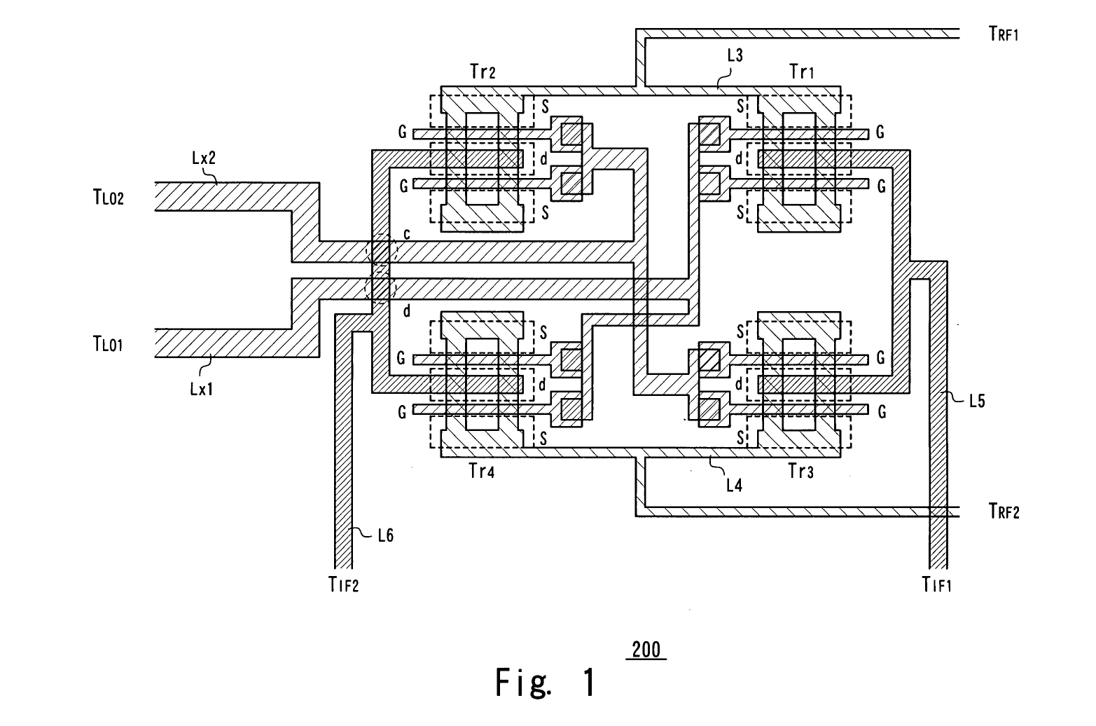

FIG. 1 shows a circuit diagram of a high frequency mixer circuit (quad ring circuit) 200 according to thepresent embodiment. Referring to FIG. 1, wiring used in a case where the transistor Tr1 is formed in an upper right region, the transistor Tr2 is formed in an upper left region, the transistor Tr3 is formed in a lower right region, and the transistor Tr4 is formed in a lower left region will be described below. In FIG. 1, respective regions are shown hatched in order to clearly define their shape.

By introducing a dopant into a surface of a semiconductor substrate, source regions S and a drain region D (shown by broken lines in FIG. 1) are formed in each of the regions where the transistors Tr1 through Tr4 are to be formed. According to the present embodiment, the source regions S are disposed above and below the drain region D to be spaced apart from the drain region D by a predetermined distance with the drain region D being located at the center. In each of the transistors Tr1 through Tr4, gate electrodes G are disposed in regions between the source regions S and the drain region D. According to the present embodiment, two gate electrodes G are provided for each of the transistors Tr1 through Tr4.

In the source regions, drain regions, and gate electrodes of the transistors Tr1 through Tr4, wiring is formed using a multi-layered metal wiring technique. Connection terminals are extended from the gate electrodes G of the transistor Tr1 in a direction toward the transistor Tr2, and connection terminals are extended from the gate electrodes G of the transistor Tr4 in a direction toward the transistor Tr3. A wiring line Lₓ1 is extended from both the gate electrodes G of the transistors Tr1 and Tr4 to be passed through between the transistors Tr2 and Tr4, and is connected to a first terminal T_{LO1} for LO signals that is located on the left side of the transistor Tr4.

Connection terminals are extended from the gate electrodes G of the transistor Tr2 in a direction toward the transistor Tr1, and connection terminals are extended from the gate electrodes G of the transistor Tr3 in a direction toward the transistor Tr4. A wiring line Lₓ2 is extended from both the gate electrodes G of the transistors Tr2 and Tr3 to be passed through between the transistors Tr2 and Tr4, and is connected to a second terminal T_{LO2} for LO signals that is located on the left side of the transistor Tr2.

The wiring lines Lₓ1 and Lx2 are formed in a multi-layered manner with an insulating layer interposed between the wiring layers of these wiring lines. Further, it is preferable that the wiring lengths of the wiring lines as measured from the first and second terminals T_{LO1} and T_{LO2} for LO signals to the gate electrodes G of the transistors Tr1 through Tr4 are set to be approximately equal to each other. Thus, the symmetry of LO signals can be maintained.

A wiring line L3 is extended from the source regions S of the transistor Tr1 in a direction away from the transistor Tr3, and is extended from the source regions S of the transistor Tr2 in a direction away from the transistor Tr4. The wiring line L3 is formed in a multi-layered manner as a wiring layer different from the wiring layers of the gate electrodes, wiring line Lₓ1, andwiring line Lₓ2 with an insulating film interposed therebetween. When each of the transistors Tr1 and Tr2 is provided with a plurality of source regions S, the source regions S are connected to each other.

The source regions S of the transistor Tr1 and the source regions S of the transistor Tr2 are electrically connected through the wiring line L3. The wiring line L3 is passed outside a region in which the transistors Tr1 and Tr2 are laid out, and is connected from the respective source regions S to a first terminal T_{RF1} for RF signals that is located on the right side of the transistor Tr1.

A wiring line L4 is extended from the source regions S of the transistor Tr3 in a direction away from the transistor Tr1, and is extended from the source regions S of the transistor Tr4 in a direction away from the transistor Tr2. The wiring line L4 is formed in a multi-layered manner as a wiring layer different from the wiring layers of the gate electrodes, wiring line Lₓ1, and wiring line Lₓ2 with an insulating film interposed therebetween. When each of the transistors Tr3 and Tr4 is provided with a plurality of source regions S, the source regions S are connected to each other.

The source regions S of the transistor Tr3 and the source regions S of the transistor Tr4 are electrically connected through the wiring line L4. The wiring line L4 is passed outside a region in which the transistors Tr3 and Tr4 are laid out, and is connected from the respective source regions S to a second terminal T_{RF2} for RF signals that is located on the right side of the transistor Tr3.

A wiring line L5 is extended from the drain region D of the transistor Tr1 in a direction away from the transistor Tr2, and is extended from the drain region D of the transistor Tr3 in a direction away from the transistor Tr4. The wiring line L5 is formed in a multi-layered manner as a wiring layer different from thewiring layers of the gate electrodes andwiring lines Lₓ1 through L4 with an insulating film interposed therebetween.

The drain region D of the transistor Tr1 and the drain region D of the transistor Tr3 are electrically connected through the wiring line L5. The wiring line L5 is passed outside a region in which the transistors Tr1 and Tr3 are laid out, and is connected from the respective drain regions D to a first terminal T_{IF1} for IF signals that is located below the transistor Tr3.

A wiring line L6 is extended from the drain region D of the transistor Tr2 in a direction away from the transistor Tr1, and is extended from the drain region D of the transistor Tr4 in a direction away from the transistor Tr3. The wiring line L6 is formed in a multi-layered manner as a wiring layer different from thewiring layers of thegate electrodes andwiring lines Lₓ1 through L4 with an insulating film interposed therebetween.

The drain region D of the transistor Tr2 and the drain region D of the transistor Tr4 are electrically connected through the wiring line L6. The wiring line L6 is passed outside a region in which the transistors Tr2 and Tr4 are laid out, and is connected from the respective drain regions D to a second terminal T_{IF2} for IF signals that is located below the transistor Tr4.

With this structure, it is preferable that the wiring lengths of the wiring lines as measured from the first and second terminals T_{RF1} and T_{RF2} for RF signals to the source regions S of the transistors Tr1 through Tr4 are set to be approximately equal to each other. Further, it is also preferable that the wiring lengths of the wiring lines as measured from the first and second terminals T_{IF1} and T_{IF2} for IF signals to the drain regions D of the transistors Tr1 through Tr4 are set to be approximately equal to each other. Thus, the symmetry of RF signals and IF signals can be maintained.

It is to be noted that the order of multi-layering in which the wiring lines Lₓ1 through L6 are layered is not limited to any particular order, and it is not necessary to stack the layers in the order described above. Further, it is preferable that the insulating films provided between the wiring layers of the gate electrodes andwiring lines Lₓ1 through L6 each have a film thickness that falls within a range in which a sufficient dielectric strength is achieved between each pair of the layers.

In the high frequency mixer circuit 200 according to the above-described embodiment, the wiring line Lₓ2 for LO signals and the wiring line L6 for IF signals overlap each other in a region “c” with an insulating film interposed therebetween, and the wiring line Lₓ1 for LO signals and the wiring line L6 for IF signals overlap each other in a region “d” with an insulating film interposed therebetween. Thus, in the regions “c” and “d” where LO signals and IF signals overlap, the wiring line L6 is coupled to the wiring lines Lₓ1 and Lₓ2 through an insulating film that functions as a capacitor.

However, because LO signals propagating along the wiring lines Lₓ1 and Lₓ2, respectively, have opposite phases to each other, the influence on IF signals in the region “c” and the influence on IF signals in the region “d” compensate each other, and therefore the influence of LO signals on IF signals can be reduced to an extremely low level.

With this structure, it is preferable that, by providing the region “c” and the region “d” close to each other, the wiring length of the wiring line as measured from the terminal T_{LO2} for LO signals to the region “c” and the wiring length of the wiring line as measured from the terminal T_{LO1} for LO signals to the region “d” are set to be approximately equal to each other. It is further preferable that the distance between the region “c” and the region “d” is set to be less than a wavelength of LO signals, and it is more preferable that the distance between the region “c” and the region “d” is set to be less than one tenth of the wavelength of LO signals. As a result, phase shifts of LO signals occurring between the wiring line Lₓ1 and the wiring line Lₓ2 due to the arrangement of the region “c” and the region “d” are reduced, and it is therefore possible to cause LO signals to have approximately opposite phases to each other in the region “c” and the region “d”.

It is to be noted that, although a wiring line for LO signals and a wiring line for IF signals are laid out to overlap each other in the above-described embodiment, the present invention is not limited to such an embodiment. Alternatively, a wiring line for LO signals and a wiring line for RF signals may also be laid out to overlap each other. However, because IF signals generally have a stronger signal strength than RF signals, it is more preferable that a wiring line for LO signals and a wiring line for IF signals are laid out to overlap each other.

Further, although the above-described embodiment is described with reference to a circuit structure that uses MESFETs, the present invention is not limited to such an embodiment. The circuit of the present invention may, for example, also be formed using MOSFET type transistors.

As described above, according to one aspect of the present invention, it is preferable that a high frequency mixer circuit comprises a quad ring circuit with four transistors, the transistors being respectively laid out in corners of a rectangular region on a substrate, wherein two gates of the transistors are connected to each other through a first wiring line, other two remaining gates of the transistors are connected to each other through a second wiring line, and the first wiring line and the second wiring line are both laid out to pass through between two of the transistors.

Further, by laying out wiring lines such that a wiring line for LO signals intersects only one of wiring lines for RF signals or IF signals, mixing of LO signals with RF signals or IF signals is reduced, and therefore the isolation between signals can be improved. Although it is also possible to obtain the above-described effects in a high frequency circuit other than a high frequency mixer circuit, the effects are remarkable particularly in a high frequency mixer circuit because, in most cases, the signal strength of LO signals is stronger than the signal strengths of RF signals and IF signals in a high frequency mixer circuit. Further, in a quad ring circuit, because a wiring line for LO signals always intersects a wiring line for RF signals or IF signals, the wiring layout of the present invention can be applied without exception.

Further, it is preferable that a pair of wiring lines for propagating radio frequency signals have approximately equal wiring lengths. Still further, it is preferable that a pair of wiring lines for propagating intermediate frequency signals have approximately equal wiring lengths.

What is claimed is:

1. A high frequency mixer circuit intended for use as a down converter in which a radio frequency signal and a local oscillation signal are mixed to generate an intermediate frequency signal, or as an up converter in which an intermediate frequency signal and a local oscillation signal are mixed to generate a radio frequency signal, the high frequency mixer circuit having a wiring layout wherein first and second wiring lines for propagating local oscillation signals intersect only one of either a wiring line for propagating radio frequency signals or a wiring line for propagating intermediate frequency signals.

2. A high frequency mixer circuit according to claim 1, wherein a point of intersection of the first wiring line and a wiring line for propagating a radio frequency signal or an intermediate frequency signal and a point of intersection of the second wiring line and a wiring line for propagating a radio frequency signal or an intermediate frequency signal are located close to each other.

3. A high frequency mixer circuit according to claim 1, wherein the first wiring line and the second wiring line have approximately equal wiring lengths.

4. A high frequency mixer circuit according to claim 2, wherein the first wiring line and the second wiring line have approximately equal wiring lengths.

5. A high frequency mixer circuit according to claim 1, wherein a pair of wiring lines for propagating radio frequency signals have approximately equal wiring lengths.

6. A high frequency mixer circuit according to claim 2, wherein a pair of wiring lines for propagating radio frequency signals have approximately equal wiring lengths.

7. A high frequency mixer circuit according to claim 3, wherein a pair of wiring lines for propagating radio frequency signals have approximately equal wiring lengths.

8. A high frequency mixer circuit according to claim 1, wherein a pair of wiring lines for propagating intermediate frequency signals have approximately equal wiring lengths.

9. A high frequency mixer circuit according to claim 2, wherein a pair of wiring lines for propagating intermediate frequency signals have approximately equal wiring lengths.

10. A high frequency mixer circuit according to claim 3, wherein a pair of wiring lines for propagating intermediate frequency signals have approximately equal wiring lengths.

11. A high frequency mixer circuit according to claim 4, wherein a pair of wiring lines for propagating intermediate frequency signals have approximately equal wiring lengths.

12. A high frequency mixer circuit according to claim 1, comprising a quad ring circuit with four transistors, the transistors being respectively laid out in corners of a rectangular region on a substrate, wherein:
two gates of the transistors are connected to each other through the first wiring line;
other two remaining gates of the transistors are connected to each other through the second wiring line; and
the first wiring line and the second wiring line are both laid out to pass through between two of the transistors.

13. A high frequency mixer circuit according to claim 2, comprising a quad ring circuit with four transistors, the transistors being respectively laid out in corners of a rectangular region on a substrate, wherein:
two gates of the transistors are connected to each other through the first wiring line;
other two remaining gates of the transistors are connected to each other through the second wiring line; and
the first wiring line and the second wiring line are both laid out to pass through between two of the transistors.
